(19) United States
(12) Patent Application Publication
(10) Pub. No.: US 2009/0102302 A1
(43) Pub. Date: Apr. 23, 2009

(54) Vehicle alternator and method of mounting the same

(75) Inventor: Hiroyuki Ogi, Tajimi-shi (JP)

Correspondence Address: OLIFF & BERRIDGE, PLC, P.O. BOX 320850, ALEXANDRIA, VA, 22320-4850, US

(73) Assignee: DENSO CORPORATION, Kariya-City (JP)

(21) Appl. No.: 12/232,981

(22) Filed: Sep. 26, 2008

(30) Foreign Application Priority Data
Oct. 18, 2007 (JP) 2007-271222

(51) Int. Cl. H02K 5/06

(52) U.S. Cl. 310/91

(57) ABSTRACT

A vehicle alternator has a rotor fixed to a rotary shaft, a stator placed around the rotor so that the stator faces an outer periphery of the rotor, and a frame accommodating the rotor and stator. The frame has a drive frame and a rear frame. The drive frame has stay parts. One stay part projects toward the outside of the vehicle alternator, and has a U-shaped hole formed at a front thereof. A circular part with a cut part is formed in the stay part. The circular part with the cut part is coaxial with the U-shaped hole and is larger in diameter and central angle than the U-shaped hole. The stay part is fastened to a mounting bracket of an internal combustion engine while the cut part of the circular part in the stay part is fitted to a step part formed in a fixing bolt.

### CROSS-REFERENCE TO RELATED APPLICATION

This application is related to and claims priority from Japanese Patent Application No. 2007-271222 filed on Oct. 18, 2007, the contents of which are hereby incorporated by reference.

### BACKGROUND OF THE INVENTION

1. Field of the invention

The present invention relates to a vehicle alternator to be fastened and mounted to a motor vehicle and others, in particular, relating to a vehicle alternator capable of being easily and accurately fastened to a mounting bracket of an internal combustion engine of the motor vehicle.

2. Description of the Related Art

A vehicle alternator receives a rotational power supplied from an internal combustion engine mounted to a motor vehicle, then generates an electric power, and charges the electric power to a battery. The vehicle alternator also supplies the electric power to various types of electrical apparatus mounted to the motor vehicle.

A recent motor vehicle trend is to have engine room width expanded in order to address safety issues in event of collisions or accidents. On the other hand, the number of devices to be mounted to the motor vehicle has also increased in order to improve safety and comfort and to follow various laws and regulations. Because those devices are densely mounted to the engine room, the space necessary to mount the vehicle alternator into the engine room is limited. This makes it difficult to mount/demount the vehicle alternator to/from the engine room.

In order to avoid the low assembling efficiency described above, one conventional technique disclosed by Japanese utility model No. JP H2-41650 discloses an improved structure of assembling a vehicle alternator to an engine room, in which the vehicle alternator has a stay part and the stay part is mounted and fixed to a mounting bracket of an internal combustion engine placed in the engine room. In particular, the stay part has clamping holes of a U-shaped groove.

Although the above conventional structure improves the efficiency of mounting/demounting the vehicle alternator to/from the internal combustion engine, the accuracy of mounting the vehicle alternator to the stay of the internal combustion engine through the clamping holes is decreased. In other words, using the clamping holes of a U-shaped groove makes it difficult to perform the positioning of the center of each clamping hole of a U-shaped groove with high accuracy. Further, the conventional structure of the vehicle alternator also makes it difficult to keep a desired accuracy of mounting the vehicle alternator to the internal combustion engine through the stay with high accuracy.

### SUMMARY OF THE INVENTION

It is an object of the present invention to provide a vehicle alternator having a structure capable of being easily mounted to an internal combustion engine side of a motor vehicle through a stay part and a mounting bracket with high accuracy.

To achieve the above purpose, the present invention provides a vehicle alternator having a rotary shaft, a rotor rotating with the rotary shaft, a stator, and a frame. The stator is placed around the rotor so that it faces an outer periphery of the rotor. The frame accommodates the rotor and the stator. The frame has a stay part. The stay part projects toward the direction of the outer periphery of the rotor. The stay part has a character U shaped hole (hereinafter, referred to as the “U-shaped hole”) formed at a front part of the stay part and a circular part with a cut part which is coaxial with the U-shaped hole. The circular part is larger in diameter than the U-shaped hole. Further, the circular part is larger in central angle than the U-shaped hole. In particular, it is desirable to form the circular part with the cut part in the surface of the stay part. Still further, it is desirable that the circular part with the cut part has a central angle of more than 180°.

In accordance with another aspect of the present invention, there is provided a method of mounting and fixing into a mounting bracket of an internal combustion engine of a motor vehicle a vehicle alternator with a frame. The frame accommodates a rotor and a stator and has a stay part. The stay part projects toward the direction of an outer periphery of the rotor. The stay part has a U-shaped hole formed at a front part of the stay part and has a circular part with a cut part and is coaxial with the U-shaped hole. The stay part is larger in diameter and central angle than the U-shaped hole.

In the method according to the present invention, the U-shaped part in the stay part is inserted into the mounting bracket of the internal combustion engine so that the cut part of the circular part in the stay part is fitted to a step part of a fixing bolt. This step part of the fixing bolt corresponds in shape to the cut part of the circular part of the stay part. The stay part is fastened to the mounting bracket while the cut part of the circular part in the stay part is fitted to the step part of the fixing bolt. In particular, using the circular part with the cut part formed in the stay part and using the fixing bolt whose shape corresponds to the shape of the circular part with the cut part easily can fit the stay part to the mounting bracket of the internal combustion engine in the assemble work. This can enhance the working efficiency of positioning the vehicle alternator into the internal combustion engine with high accuracy through the mounting bracket, the stay part having the U-shaped part and the circular part with the cut part, and the fixing bolt with the step part.

### BRIEF DESCRIPTION OF THE DRAWINGS

A preferred, non-limiting embodiment of the present invention will be described by way of example with reference to the accompanying drawings, in which:

FIG. 1 is a partial sectional view of an entire structure of a vehicle alternator having a drive frame with a pair of stay parts according to an embodiment of the present invention;

FIG. 2A shows a detailed shape of a U-shaped hole and a circular part with a cut part formed in one stay part of the drive frame in the vehicle alternator according to the embodiment of the present invention shown in FIG. 1;

FIG. 2B is a sectional view of the U-shaped hole formed in the stay part of the drive frame shown in FIG. 2A;

FIG. 3 shows a state before assembling the vehicle alternator having the drive frame with the stay parts having the U-shaped hole and the circular part with the cut part shown in FIG. 1, FIG. 2A and FIG. 2B into a mounting bracket of an internal combustion engine of a motor vehicle;

FIG. 4 shows a state after completion of assembling the vehicle alternator having the drive frame according to the embodiment of the present invention shown in FIG. 1, FIG. 2A and FIG. 2B into the mounting bracket of the internal combustion engine;

FIG. 5 shows a state before assembling a conventional vehicle alternator having a drive frame with a pair of stay parts having a conventional U-shaped hole into a mounting bracket of an internal combustion engine of a motor vehicle;

FIG. 6 shows a state after completion of assembling the conventional vehicle alternator having the drive frame with the stay parts having the conventional U-shaped hole into the mounting bracket of the internal combustion engine;

FIG. 7 shows a state before assembling a conventional vehicle alternator having a drive frame with a pair of stay parts having a conventional circular hole into a mounting bracket of an internal combustion engine;

FIG. 8 shows a state after completion of assembling the conventional vehicle alternator having the drive frame with the stay parts having the conventional circular hole into the mounting bracket of the internal combustion engine; and

FIG. 9 is a flow chart of assembling the vehicle alternator according to the present invention into the internal combustion engine through the mounting bracket, stay part with the U-shaped hole and the circular part with the cut part, and the fixing bolt.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Embodiment

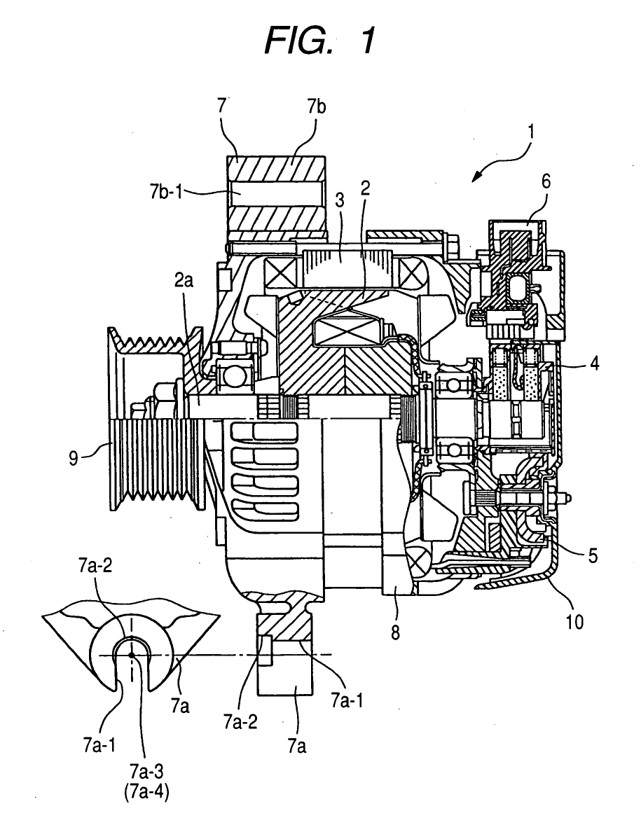

A description will be given of a preferred embodiment of the present invention with reference to FIG. 1 to FIG. 4.

FIG. 1 is a partial sectional view of an entire structure of a vehicle alternator 1 having a drive frame 7 with a pair of stay parts 7a and 7b according to an embodiment of the present invention. The vehicle alternator 1 shown in FIG. 1 has a built-in cooling fan.

The vehicle alternator 1 shown in FIG. 1 is comprised of a rotor 2, a stator 3, a brush device 4, a rectifying device 5, an IC regulator 6, a drive frame 7, a rear frame 8, a pulley 9, a rear cover 10, and others.

The rotor 2 is fixed to a rotary shaft 2a and rotates with the rotary shaft 2a. The stator 3 is placed at the outer periphery of the rotor 2 so that the stator 3 faces the rotor 2.

The drive frame 7 and the rear frame 8 accommodate the rotor 2 and the stator 3. The drive frame 7 is placed at the pulley 9 side and has a pair of the stay parts 7a and 7b. Those stay parts 7a and 7b project toward the outer periphery direction of the vehicle alternator 1 (namely, in the direction perpendicular to the rotary shaft 2a).

A character U shaped hole 7a-1 (hereinafter, referred to as the “U-shaped hole 7a-1”) is formed in one stay part 7a. On the other hand, a circular hole 7b-1 is formed in the other stay part 7b. The vehicle alternator 1 is fastened and fixed to the internal combustion engine (not shown) of the motor vehicle by a fixing means such as fixing bolts (which will be explained in detail) through the U-shaped hole 7a-1 and the circular hole 7b-1.

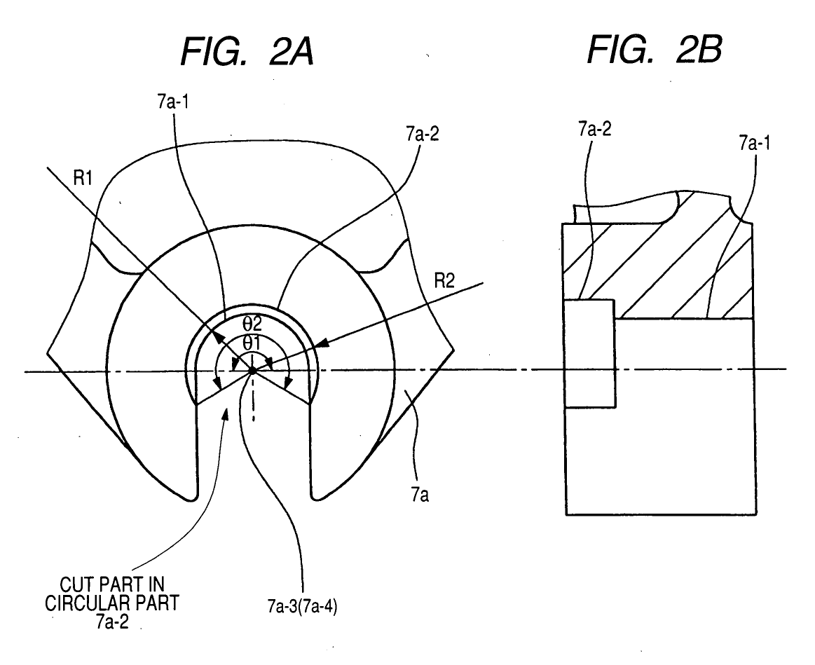

In particular, the stay part 7a has the U-shaped hole 7a-1. The U-shaped hole 7a-1 has a circular part 7a-2 having a cut part. In other words, the circular part 7a-2 is formed in the surface of the U-shaped hole 7a-1 in the stay part 7a. As shown in FIG. 2A and FIG. 2B, a central angle of the circular part 7a-2 with the cut part is larger than that of the U-shaped hole 7a-1.

It is so formed that the center axis 7a-3 of the U-shaped hole 7a-1 is equal to the center axis of the circular part 7a-2 with the cut part. In other words, as shown in FIG. 2A, the U-shaped hole 7a-1 and the circular part 7a-2 having the cut part are coaxially formed in the stay part 7a.

The drive frame 7 and the rear frame 8 are assembled together with high accuracy so that the rotor 3 freely rotates therein.

FIG. 2A shows a detailed structure of the U-shaped hole 7a-1 formed in the stay part 7a of the drive frame 7 in the vehicle alternator 1 according to the embodiment shown in FIG. 1. FIG. 2B is a sectional view of the U-shaped hole 7a-1 formed in the stay part 7a of the drive frame 7 shown in FIG. 2A.

In particular, FIG. 2A shows a plane shape of the stay part 7a observed from one surface side in which the circular part 7a-2 with the cut part is formed. On the other hand, FIG. 2B shows a sectional shape of the stay part 7a having the U-shaped hole 7a-1 and the circular part 7a-2 with the cut part.

As shown in FIG. 2A, the radius R2 of the circular part 7a-2 with the cut part is a larger than the radius R1 of the U-shaped hole 7a-1. This structure enables the circular part 7a-2 to have a large central angle θ2 (having the radius R2) rather than that of the central angle θ1=180° of the front end part R (having the radius R1) of the U-shaped hole 7a-1.

That is, the circular part 7a-2 with the cut part has a cylindrical-like shape rather than the U-shaped hole 7a-1. The structure of the drive frame 7 having the circular part 7a-2 with the cut part makes it possible to easily perform the positioning of the center axis (the center axis 7a-3) of the radius R1 of the U-shaped hole 7a-1 when compared with the structure having the U-shaped hole 7a-1 without the circular part 7a-2 with the cut part.

That is, this increases the accuracy and efficiency of assembling the vehicle alternator 1 into the internal combustion engine of a motor vehicle, and decreases the assembling time thereof.

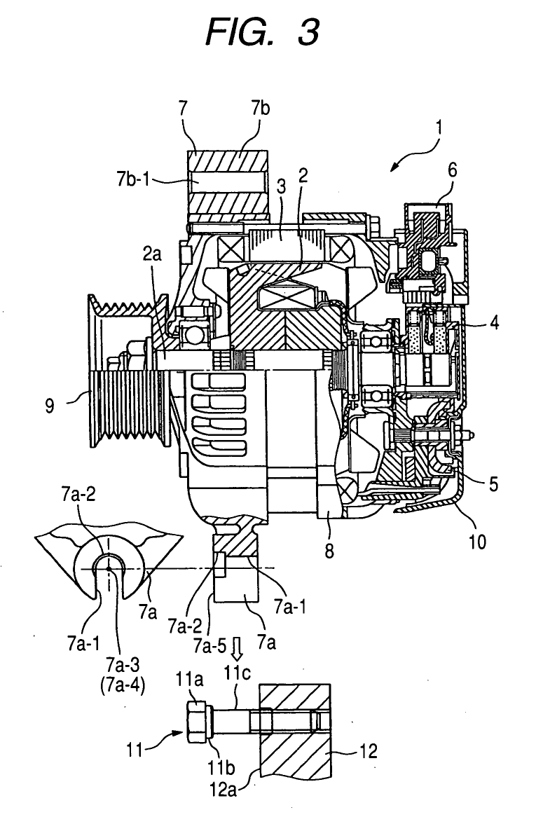

FIG. 3 shows a state before assembling the vehicle alternator 1 having the drive frame 7 with the stay parts 7a and 7b shown in FIG. 1, FIG. 2A, and FIG. 2B into the mounting bracket 12 of the internal combustion engine (not shown) of the motor vehicle.

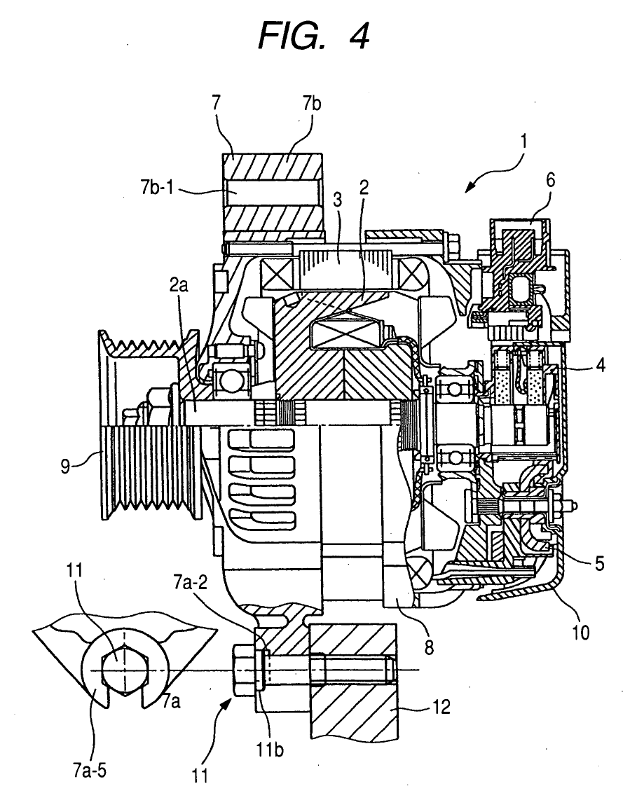

FIG. 4 shows a state after completion of assembling the vehicle alternator 1 according to the embodiment shown in FIG. 1, FIG. 2A and FIG. 2B into the mounting bracket 12 of the internal combustion engine.

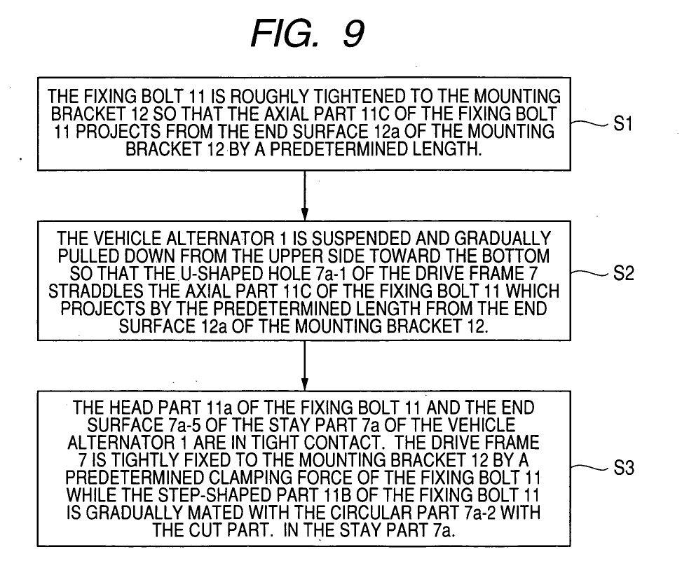

FIG. 9 is a flow chart showing a method of assembling the vehicle alternator 1 according to the embodiment of the present invention into the internal combustion engine (not shown) through the mounting bracket 12 and the fixing bolt 11.

The vehicle alternator 1 according to the embodiment is mounted to the mounting bracket 12 using the fixing bolt 11. This fixing bolt 11 corresponds in shape to the stay part 7a. A step-shaped part 11b is formed at a head part 11a of the fixing bolt 11. The step-shaped part 11b has a large diameter rather than the axial part 11c of the fixing bolt 11.

In the mounting or assembling work of the vehicle alternator into the mounting bracket 12 of the internal combustion engine of the motor vehicle (not shown), the fixing bolt 11 is roughly tightened to the mounting bracket 12 while the axial part 11c of the fixing bolt 11 projects from the end surface 12a of the mounting bracket 12 by a predetermined length, in step S1 shown in FIG. 9.

In step S2, the vehicle alternator 1 is suspended and gradually pulled down from the upper side toward the bottom side shown in FIG. 3 so that the U-shaped hole 7a-1 of the drive frame 7 straddles the axial part 11c of the fixing bolt 11 which projects from the end surface 12a of the mounting bracket 12 by the predetermined length.

In step S3, the head part 11a of the fixing bolt 11 and the end surface 7a-5 of the stay part 7a of the vehicle alternator 1 are in tight contact, and the drive frame 7 of the vehicle alternator 1 is tightly fastened and fixed to the mounting bracket 12 by a predetermined clamping force of the fixing bolt 11 while the step-shaped part 11b of the fixing bolt 11 is gradually mated with the circular part 7a-2 with the cut part of the stay part 7a.

That is, during the above mounting step, the step-shaped part 11b of the fixing bolt 11 works so that the center axis 7a-3 of the U-shaped part 7a-1 of the vehicle alternator 1 easily and accurately mates with the step-shaped part 11b of the fixing bolt 11. In other words, the step-shaped part 11b of the fixing bolt 11 acts as an automatic adjusting means for automatically adjusting both the axis of the fixing bolt 11 and the U-shaped part 7a-1.

After completion of the fastening work of the stay parts 7a and 7b using the fixing bolt 11 for the stay part 7a and another fixing bolt for the stay part 7b (omitted from drawings) to the mounting bracket 12, the vehicle alternator 1 is assembled at a correct position into and correctly faces the internal combustion engine (not shown) of the motor vehicle with high accuracy.

### COMPARISON EXAMPLE

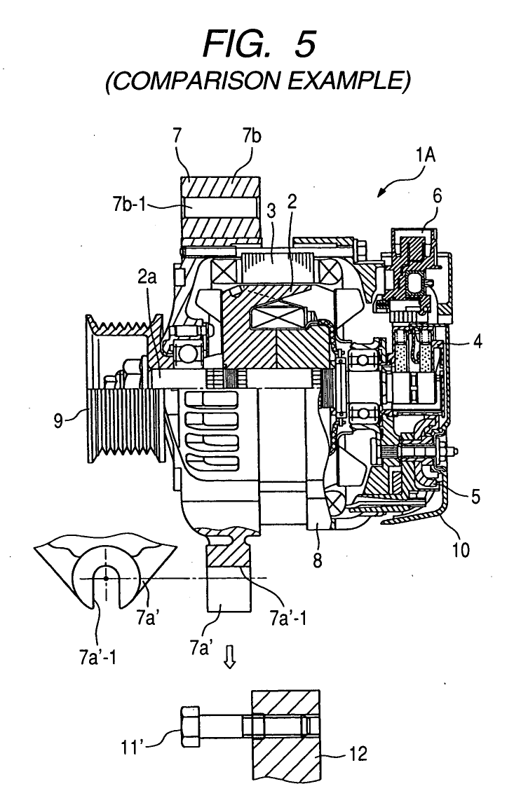

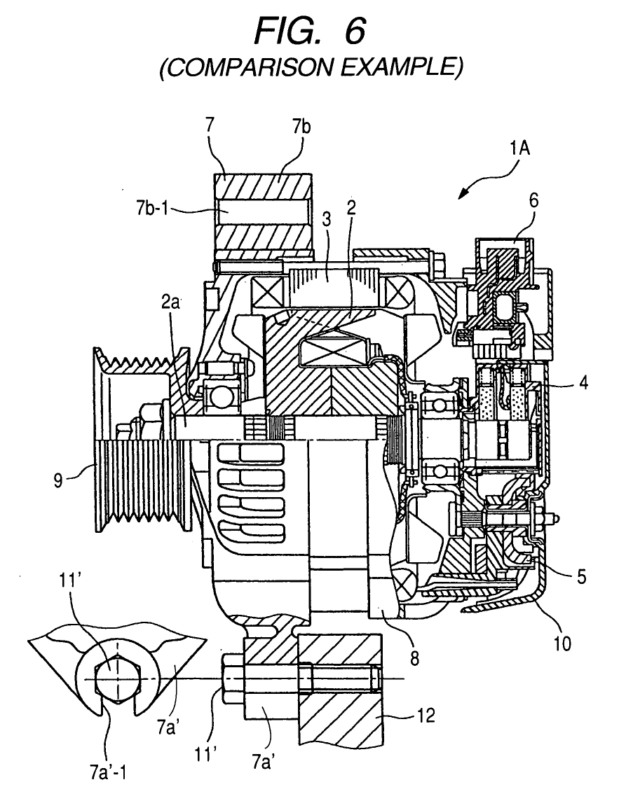

A description will now be given of a conventional vehicle alternator 1A as a comparison example with reference to FIG. 5 and FIG. 6.

FIG. 5 shows a state before assembling the conventional vehicle alternator 1A having a drive frame 7′ with a pair of stay parts 7a′ and 7b having a conventional U-shaped hole 7a′-1 into a mounting bracket 12 of an internal combustion engine. FIG. 6 shows a state after completion of the assembling work for the conventional vehicle alternator 1A having the drive frame 7′ with the stay parts 7a′ and 7b having the conventional U-shaped hole 7a′-1 into the mounting bracket 12 of an internal combustion engine.

The conventional vehicle alternator 1A shown in FIG. 5 and FIG. 6 is mounted to the mounting bracket 12 at an internal combustion engine (not shown) side using a fixing bolt 11′ which has not any step-shaped part.

As shown in FIG. 5 and FIG. 6, the conventional vehicle alternator 1A has a rough degree of freedom in positioning because the conventional vehicle alternator 1A has the conventional U-shaped hole 7a′-1 without any step-shaped part. This leads to the possibility of deteriorating the positioning accuracy for assembling the conventional U-shaped hole 7a′-1 into the mounting bracket 12. Such a conventional structure of the drive frame 7′ further leads a possibility of slanting the conventional vehicle alternator 1A to the internal combustion engine (not shown) through the mounting bracket 12.

This conventional case makes it difficult to stably mount the conventional vehicle alternator 1A at a desired position to the internal combustion engine through the mounting bracket 12. Accordingly, this deteriorates alignment of a rotary surface of a pulley 9 and makes it difficult to connect electrical wires placed in the internal combustion engine side to the conventional vehicle alternator 1A.

### ANOTHER COMPARISON EXAMPLE

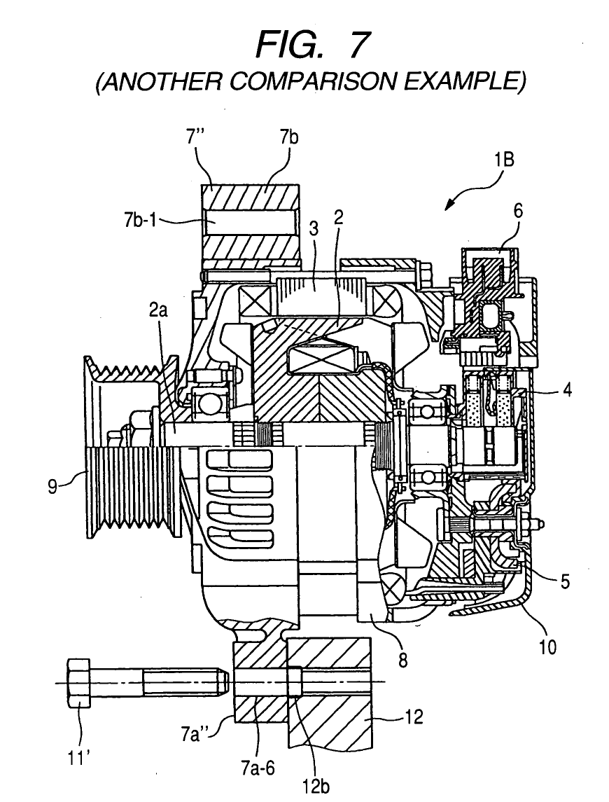

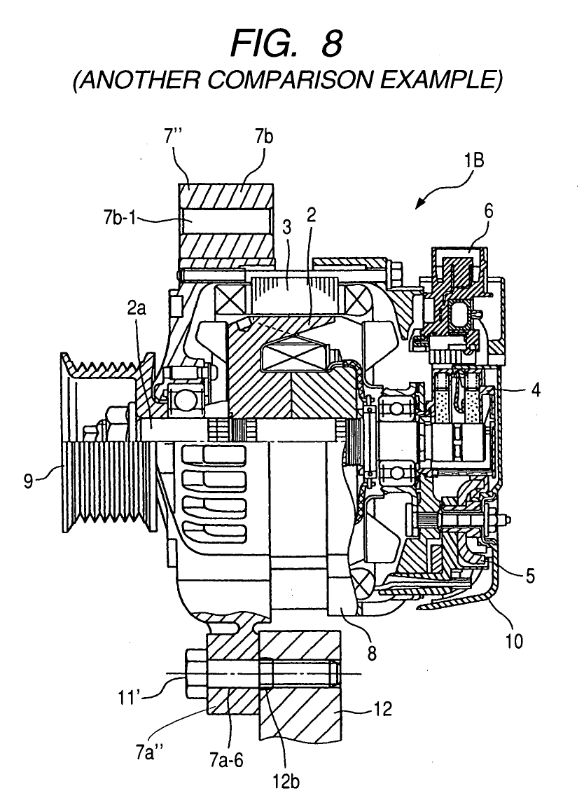

A description will now be given of a conventional vehicle alternator as another comparison example with reference to FIG. 7 and FIG. 8.

FIG. 7 shows a state before assembling another conventional vehicle alternator 1B having a drive frame 7″ with a pair of stay parts 7a″ and 7b having a conventional circular hole 7a-6 into a mounting bracket 12 of an internal combustion engine. FIG. 8 shows a state after completion of the assembling work for the conventional vehicle alternator 1B having the drive frame 7″ with the stay parts 7a″ and 7b having the conventional circular hole 7a-6 into the mounting bracket 12 of the internal combustion engine.

The conventional vehicle alternator 1B shown in FIG. 7 and FIG. 8 is mounted to an internal combustion engine (not shown) through the mounting bracket 12 using the fixing bolt 11′ without any step-shaped part.

As shown in shown in FIG. 7 and FIG. 8, because the stay part 7a″ in the conventional vehicle alternator 1A has not any U-shaped hole, the structure of the conventional vehicle alternator 1B can avoid the drawbacks caused in the conventional vehicle alternator 1A shown in FIG. 5 and FIG. 6, where one drawback is to deteriorate the positioning accuracy of assembling the vehicle alternator to the internal combustion engine, and the other drawback is to slant the conventional vehicle alternator 1A to the internal combustion engine.

However, when the conventional vehicle alternator 1B shown in FIG. 7 and FIG. 8 is assembled into the internal combustion engine (not shown), it is necessary to adjust the circular hole 7a-6 formed in the stay part 7a″ of the drive frame 7″ and the fixing hole 12b formed in the mounting bracket 12 in a coaxial line, and then to insert the fixing bolt 11′ into the fixing hole 12b along the coaxial line.

This structure of the conventional vehicle alternator 1B shown in FIG. 7 and FIG. 8 requires complicated assembling work to the internal combustion engine. Further, it is completely difficult to mount and demount the conventional vehicle alternator 1B into/from the internal combustion engine through the mounting bracket 12 in the engine room when the engine room has a narrow space.

The concept of the vehicle alternator according to the present invention is not limited by the structure of the vehicle alternator of the aforementioned embodiment. It is possible to apply various modifications of the present invention to the vehicle alternators within the concept of the present invention. For example, although the aforementioned embodiment discloses the structure in which the drive frame 7 has the stay part 7a with the U-shaped hole 7a-1, it is possible to have the rear frame 8 having the stay part 7a with the U-shaped hole 7a-1.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A vehicle alternator comprising:
a rotary shaft;
a rotor fixed to the rotary shaft rotating with the rotary shaft;
a stator placed around the rotor so that it faces an outer periphery of the rotor; and
a frame which accommodates the rotor and the stator,
the frame comprising a stay part which projects toward the direction of the outer periphery of the rotor, and the stay part having a U-shaped hole formed at a front part of the stay part and a circular part with a cut part, the circular part with the cut part being coaxial with the U-shaped hole, and the circular part being larger in diameter and central angle than the U-shaped hole.

2. The vehicle alternator according to claim 1, wherein the circular part with the cut part is formed in the surface of the stay part.

3. The vehicle alternator according to claim 1, wherein the circular part with the cut part has a central angle of not less than 180°.

4. The vehicle alternator according to claim 2, wherein the circular part with the cut part has a central angle of not less than 180°.

5. The vehicle alternator according to claim 1, wherein the stay part in the vehicle alternator is fastened to a mounting bracket of an internal combustion engine of a motor vehicle using a fixing bolt having a step part which corresponds in shape to the circular part with the cur part in the stay part.

6. The vehicle alternator according to claim 2, wherein the stay part in the vehicle alternator is fastened to a mounting bracket of an internal combustion engine of a motor vehicle using a fixing bolt having a step part which corresponds in shape to the circular part with the cur part in the stay part.

7. A method of fastening into a mounting bracket of an internal combustion engine of a motor vehicle a vehicle alternator with a frame which accommodates a rotor and a stator and has a stay part projecting toward the direction of an outer periphery of the rotor, in which the stay part has a U-shaped hole formed at a front part of the stay part, has a circular part with a cut part and is coaxial with the U-shaped hole, and is larger in diameter and central angle than the U-shaped hole,
the method comprising:
inserting the U-shaped part of the stay part into the mounting bracket so that the cut part of the circular part in the stay part is fitted to a step part formed in a fixing bolt, in which the step part of the fixing bolt corresponds in shape to the cut part of the circular part of the stay part; and
fastening the stay part to the mounting bracket while the cut part of the circular part in the stay part is fitted to the step part of the fixing bolt.
